(19) United States
(12) Patent Application Publication
(10) Pub. No.: US 2006/0199069 A1
(43) Pub. Date: Sep. 7, 2006

(54) Membrane electrode assembly, method for manufacturing the same, and polymer electrolyte fuel cell

(75) Inventors: Makoto Kubota, Kawasaki-shi (JP); Motokazu Kobayashi, Yokohama-shi (JP); Keiko Abe, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/357,047

(22) Filed: Feb. 21, 2006

(30) Foreign Application Priority Data
Mar. 2, 2005 (JP) 2005-057996

(51) Int. Cl. H01M 4/94; H01M 8/10; H01M 4/88

(52) U.S. Cl. 429/44; 429/30; 429/33; 502/101

(57) ABSTRACT

A membrane electrode assembly composed of a polymer electrolyte membrane and diffusion layers bonded to both surfaces of the polymer electrolyte membrane, as well as a polymer electrolyte fuel cell including the membrane electrode assembly, are provided. The polymer electrolyte membrane includes a porous polymer membrane, proton conductive groups disposed in pores of the porous polymer membrane, and a catalyst-supporting conductive material embedded in the pores at least in the neighborhood of at least one surface of the porous polymer membrane. A method for forming the assembly and a polymer electrolyte fuel cell including the assembly are also provided.

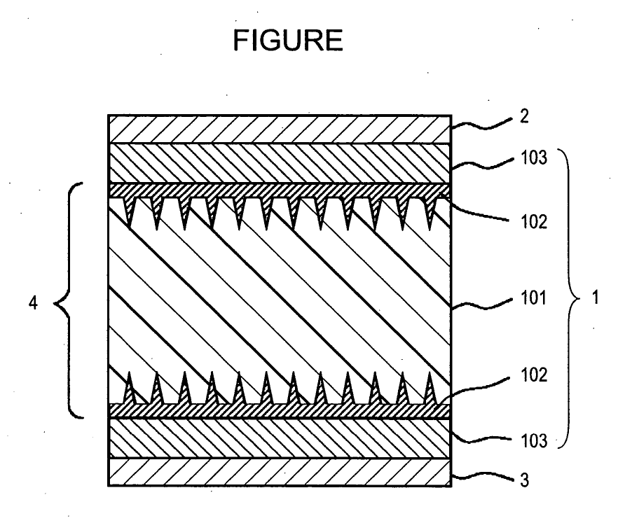

### BACKGROUND OF THE INVENTION

1. Field of the Invention

The present invention relates to a membrane electrode assembly for a polymer electrolyte fuel cell, a method for manufacturing a membrane electrode assembly, and a polymer electrolyte fuel cell. In particular, it relates to a membrane electrode assembly in which the efficiency of electric power generation is increased by improving a mutual contact state of constituent components.

2. Description of the Related Art

Fuel cells are used to convert chemical energy of a fuel into electrical energy by electrochemically oxidizing the fuel made of a reducing agent, for example, hydrogen, methanol, or reformed hydrogen derived from fossil fuel, with an oxidizing agent, for example, oxygen or air. Among such cells is a polymer electrolyte fuel cell. A first advantage of the polymer electrolyte fuel cell is that its operation temperature is low. A second advantage is that current can be produced with a high efficiency, because the internal resistance can be reduced by using a thin membrane as an electrolyte. The use of a thin membrane as the electrolyte also allows miniaturization of the cell.

A membrane electrode assembly used for this polymer electrolyte fuel cell has a structure in which an anode (fuel electrode) and a cathode (air electrode) are bonded with a polymer electrolyte membrane between the electrodes. The polymer electrolyte fuel cell can be made, for example, by laminating the membrane electrode assemblies, with each cell sandwiched by separators.

The above-described anode or cathode and the polymer electrolyte membrane are bonded with a catalyst-supporting conductive material composed of a mixture of a catalyst and electrically conductive carbon and diffusion layers, which are nonlinearly permeated by a gas or a liquid. A fuel supplied to the anode side passes through the pores in the diffusion layer to reach the catalyst, and is converted to hydrogen ions while electrons are released due to the presence of the catalyst. The hydrogen ions pass through the polymer electrolyte membrane to reach the cathode side and react with oxygen supplied to the diffusion layer on the cathode side and electrons provided from an external circuit, generating water. The electrons released from the fuel pass through the catalyst and the electrically conductive carbon carrying the catalyst in the electrode and are led out of the anode to the external circuit so as to flow into the cathode from the external circuit. As a result, the electrons flow from the anode toward the cathode, so that electricity is generated.

At this time, if the bonding between the polymer electrolyte membrane and the electrodes (anode and cathode) is inadequate, the movement of the hydrogen ions is hindered at the interfaces between the electrodes and the polymer electrolyte membrane. Consequently, the internal resistance of the entire membrane electrode assembly increases. The bonding interfaces between the polymer electrolyte membrane and the electrodes are also three-phase interfaces in which a catalytic reaction occurs. More hydrogen ions are generated as the areas of the three-phase interfaces increase. That is, the bonding of the polymer electrolyte membrane and the electrodes in the membrane electrode assembly greatly influences the properties of the polymer electrolyte fuel cell.

Japanese Patent Laid-Open No. 8-106915 discloses a method for manufacturing a known membrane electrode assembly in which a polymer electrolyte membrane is hot-pressed while being sandwiched by gas diffusion electrodes. Thereby, the polymer electrolyte membrane and the gas diffusion electrodes are bonded together.

Japanese Patent Laid-Open No. 2004-247152 discloses another such method in which an electrolyte membrane produced by filling an electrolyte component in a porous membrane primarily containing polyimide is coated with a paste for forming a catalyst layer, followed by drying.

However, in the membrane electrode assemblies produced by known manufacturing methods, the bonding at the interfaces between the electrolyte membrane and the diffusion layers is still inadequate, and the three-phase interface is not yet adequately three-dimensional. This inadequate bonding leads to an increase in the internal resistance of the cell and a reduction in the utilization factor of the catalyst. Consequently, adequate output properties of the polymer electrolyte fuel cell have not been attained through the use of the membrane electrode assemblies produced by known manufacturing methods.

Furthermore, in both cases where the electrolyte membrane is hot-pressed while being sandwiched by the diffusion layers and where the electrolyte membrane produced by filling the electrolyte component in the porous membrane is coated with the paste for forming a catalyst layer, followed by drying, the bonding interfaces between the electrolyte membrane and the diffusion layers are substantially flat. That is, in the electric power generation environment, the adhesion strength of the interfaces cannot be deemed adequate, and peeling may occur at the interfaces. Therefore, the bonding strength between the electrolyte membrane and the diffusion layers must be improved.

### SUMMARY OF THE INVENTION

The present invention provides a membrane electrode assembly exhibiting excellent strength and having an excellent high-output electric power generation capacity by reducing the internal resistance by improving the bonding between components constituting the membrane electrode assembly and increasing the reaction area by allowing the three-phase interface to become three-dimensional. The invention also provides a method for manufacturing a membrane electrode assembly and a polymer electrolyte fuel cell.

A first aspect of the present invention is a membrane electrode assembly composed of a polymer electrolyte membrane and diffusion layers bonded to both surfaces of the polymer electrolyte membrane, wherein the polymer electrolyte membrane includes a porous polymer membrane, proton conductive groups disposed in the pores of the porous polymer membrane, and a catalyst-supporting conductive material embedded in the pores at least in the neighborhood of at least one surface of the porous polymer membrane. Here, the phrase “in the pores in the neighborhood of the surface” refers to a part of the inside of the pores communicating with opening portions on the surface of the porous polymer membrane.

The above-described proton conductive groups and the above-described porous polymer membrane can be chemically bonded together. The chemical bond refers to any one of an ionic bond, a covalent bond, a coordinate bond, a metallic bond, and a hydrogen bond.

The above-described proton conductive groups can be sulfonic groups and/or phosphoric groups.

The thickness of the above-described porous polymer membrane can be about 15 μm or more and about 150 μm or less.

The depth of embedding of the above-described catalyst-supporting conductive material can be about 1% or more and less than about 50% of the thickness of the above-described porous polymer membrane.

The average diameter of the pores observed on the surface of the above-described porous polymer membrane can be about 0.1 μm or more and about 10 μm or less.

The above-described porous polymer membrane can be insoluble in water. The porous polymer membrane can be made of any one polymer selected from the group consisting of a polyimide polymer, a polytetrafluoroethylene polymer, a polyamide polymer, a polyimide-amide polymer, and a polyolefin polymer. A second aspect of the present invention is a method for manufacturing a membrane electrode assembly, the method including at least the steps of bringing a functional compound comprising a sulfonic group and/or a compound containing a phosphoric group into contact with pore portions of a porous polymer membrane; chemically bonding the above-described porous polymer membrane and the above-described functional-compound together by electron beam irradiation; removing excess functional compounds present in the neighborhood of surfaces of the above-described porous polymer membrane; applying a precursor paste of a catalyst-supporting conductive material to the neighborhood of the surfaces of the above-described porous polymer membrane; and drying the above-described paste after diffusion layers are affixed to the surfaces of the above-described paste.

A third aspect of the present invention is a polymer electrolyte fuel cell including the above-described membrane electrode assembly.

Further features of the present invention will become apparent from the following description of exemplary embodiments with reference to the attached drawing.

### BRIEF DESCRIPTION OF THE DRAWINGS

The FIGURE is a schematic sectional view showing the general configuration of a polymer electrolyte fuel cell of the present invention.

### DESCRIPTION OF THE EMBODIMENTS

The embodiments of the present invention will be described below.

Features of Membrane Electrode Assembly and Polymer Electrolyte Fuel Cell

The FIGURE schematically shows a general configuration of a polymer electrolyte fuel cell produced in the present invention. Reference numeral 101 denotes a porous polymer membrane, reference numeral 102 denotes a catalyst-supporting conductive material, reference numeral 103 denotes a diffusion layer, reference numeral 2 denotes an anode, reference numeral 3 denotes a cathode, and reference numeral 4 denotes a polymer electrolyte membrane. Although not shown in the FIGURE, proton conductive groups are disposed in the pores of the porous polymer membrane 101.

In the present invention, the assembly composed of the porous polymer membrane 101, proton conductive groups (not shown), catalyst-supporting conductive material 102, and diffusion layers 103 is referred to as a membrane electrode assembly 1.

The present invention will be described below with reference to the FIGURE. However, the configurations and the shapes of the membrane electrode assembly and the polymer electrolyte fuel cell of the present invention are not limited to those shown in the FIGURE.

The material for the porous polymer membrane 101 in the present invention is selected from water-insoluble polymer materials. Specifically, various polyimide base (for example, UPILEX produced by UBE INDUSTRIES, LTD.), polytetrafluoroethylene base (for example, Porous PTFE Membrane produced by NITTO DENKO CORPORATION), polyamide base, polyimide-amide base, polyolefin base resin materials, and the like, can be used. In the case where methanol is selected as a fuel for the membrane electrode assembly of the present invention, the porous polymer membrane 101 is selected from materials, which are insoluble in methanol and water and which substantially do not swell in the presence of methanol and water. Among the above-described materials, a polyimide base material is preferred from the viewpoint of its insolubility in methanol and water, physical strength, and chemical stability.

The polyimide polymers are polyimides and derivatives thereof. The same type of definition applies to other above-listed polymers.

In the present invention, the porosity indicates a state in which a plurality of fine pores are present in the polymer membrane material. These pores are not independent of one another and they can be mutually and appropriately connected to form paths through which gases and liquids can permeate from one surface of the membrane toward the other surface. However, if the gases and liquids can pass through without resistance, fuel may also be able to pass (fuel crossover), deteriorating the performance of the cell. Therefore, to avoid this problem, pores can be nonlinearly connected so as to increase the distance that a fluid (liquid or gas) has to travel. The degree of permeation can be controlled by the membrane thickness and the pore size of the porous polymer membrane 101.

The membrane thickness and the pore size of the porous polymer membrane 101 depend on the material from which the membrane is constructed, the strength of the required membrane electrode assembly, the properties of the required polymer electrolyte fuel cell, and the like, and are not specifically limited. However, the membrane thickness suitable for the use in general polymer electrolyte fuel cells is, preferably, about 15 μm or more and about 150 μm or less, more preferably, about 30 μm or more and about 100 μm or less. If the membrane thickness of the porous polymer membrane 101 is less than 15 μm, the strength during construction of the membrane electrode assembly and during the use as the polymer electrolyte fuel cell is unsatisfactory. However, if the membrane thickness exceeds about 150 μm, the efficiency of electric power generation is reduced, because the proton movement distance becomes too long.

The average diameter of the pores observed on the surface of the porous polymer membrane 101 is, preferably, about 0.1 μm or more and about 10 μm or less, more preferably, about 0.1 μm or more and about 5 μm or less. If the average diameter of the pores observed on the surface of the porous polymer membrane 101 is less than about 0.1 μm, the efficiency of the electric power generation is reduced, because the number of sites suitable for the presence of proton conductive groups is reduced to a level that is too low. However, if the average diameter exceeds about 10 μm, the amount of the fuel crossover increases and a reverse reaction may occur on the cathode side.

In the present invention, proton conductive groups are disposed in the pores of the above-described porous polymer membrane 101. The proton conductive groups must be physically or chemically adsorbed by the porous polymer membrane 101 with strength at a level adequate for preventing the proton conductive groups from flowing out during the electric power generation reaction. It is particularly preferred for the proton conductive groups and the porous polymer membrane 101 to be chemically bonded together. The proton conductive groups and the porous polymer membrane 101 may be directly chemically bonded. Alternatively, compounds having proton conductive groups at terminals and the porous polymer membrane 101 may be chemically bonded.

The proton conductive group in the present invention refers to a functional group exhibiting proton conductivity. Examples thereof include a sulfonic group, a sulfinic group, a carboxylic group, a phosphonic group, a phosphoric group, a phosphinic group, and a boric group. Among them, the sulfonic group and/or the phosphoric group are particularly preferred. Both the sulfonic group and the phosphoric group exhibit a high degree of acid dissociation. Therefore, these groups greatly improve the proton transport efficiency of the membrane.

In the present invention, a part of or the entire catalyst-supporting conductive material 102 is embedded in the pores in the neighborhood of at least one surface of the above-described porous polymer membrane 101. The depth of embedding is not specifically limited. However, the depth of embedding on one surface basis is, preferably, about 1% or more and less than about 50% of the thickness of the porous polymer membrane 101. In the case where the catalyst-supporting conductive materials 102 are embedded in both surfaces, the total of the depths of embedding of the two surfaces is, preferably, about 2% or more and less than about 100% of the thickness of the porous polymer membrane 101.

The term “depth of embedding” in the present invention indicates a maximum depth at which the catalyst-supporting conductive material 102 is present continuously in the porous polymer membrane 101. This depth is measured from the surface of the porous polymer membrane 101. If the depth of embedding is less than about 1% of the thickness of the porous polymer membrane 101, an improvement in the bonding between the components and the formation of a three-dimensional interface cannot be achieved. However, if the depth of embedding is about 50% or more of the thickness of the porous polymer membrane 101, when the catalyst-supporting conductive materials 102 are embedded in both surfaces, they may come into contact with each other, causing the cell to “leak” electricity. When the embedding is conducted in only one surface, portions not contributing to the electric power generation are excessively increased.

In the present invention, the constituent components of the catalyst-supporting conductive material are not specifically limited. However, electrically conductive carbon and an electrode catalyst can be included, as in general membrane electrode assemblies. For example, the catalyst-supporting conductive material on the anode side is formed from a conductive carbon carrying a metal catalyst including at least platinum. Other Group VIII A metals, such as, rhodium, ruthenium, iridium, palladium and osmium, may be used in lieu of platinum. An alloy of platinum and the above-described metals may also be used. In particular, in the case where methanol is used as the fuel, the alloy of platinum and ruthenium can be used.

The above-described metal catalyst can be carried on the surface of the electrically conductive carbon. The average particle diameter of the carried metal catalyst is, preferably, about 1 nm or more and about 10 nm or less, more preferably, about 2 nm or more and about 6 nm or less. If the particle diameter of the metal catalyst is less than about 1 nm, a catalyst particle is too highly active alone, and is, therefore, difficult to handle. However, if the particle diameter of the metal catalyst exceeds about 10 nm, the surface area of the catalyst decreases, and, therefore, its activity may be reduced.

The electrically conductive carbon may be, for example, carbon black, carbon fiber, graphite, carbon nanotube, and the like. The average particle diameter of the electrically conductive carbon is, preferably, about 5 nm or more and about 1,000 nm or less, more preferably, about 10 nm or more and about 100 nm or less. A somewhat large specific surface area is suitable for carrying the above-described catalyst. The specific surface area is, preferably, about 50 m²/g or more and about 3,000 m²/g or less, more preferably, about 100 m²/g or more and about 2,000 m²/g or less.

The catalyst-supporting conductive material on the cathode side is also formed from a similar electrode catalyst.

The diffusion layers 103 uniformly introduce the fuel and the oxidizing agent gas into the electrode catalyst layer at a high efficiency and bring them into contact with the electrode, so that an exchange of electrons can occur. In general, conductive porous membranes are suitable, and carbon paper, carbon cloth, composite sheets of carbon and polytetrafluoroethylene, and the like, can be used. This diffusion layer 103 may be used after the surface and/or the inside is subjected to a water repelling treatment by being coated with a fluorine-based paint.

The thickness of the diffusion layer 103 is, preferably, about 0.1 μm or more and about 500 μm or less. If the thickness of the diffusion layer 103 is less than about 0.1 μm, the gas diffusivity and the water repellency become unsatisfactory. However, if the thickness of the diffusion layer 103 exceeds about 500 μm, undesirably, the electrical resistance of the diffusion layer 103 and the ohmic loss increase. A more preferred thickness of the diffusion layer 103 is about 1 μm or more and about 300 μm or less.

The anode 2 and the cathode 3 are electrodes that transport to the outside the current generated in the membrane electrode assembly 1, and they can be composed of electrically conductive materials. Each of the anode 2 and the cathode 3 may also serve as a flow path plate to supply the fuel and the oxidizing agent gas to the diffusion layer 103. That is, the anode 2 and the cathode 3 are not necessarily flat plates, and may take on the shape patterned into a current-out transport portion and a flow path groove.

The polymer electrolyte fuel cell of the present invention is produced by using the above-described membrane electrode assembly of the present invention. The FIGURE shows an example of a minimum configuration of the polymer electrolyte fuel cell of the present invention. However, a practical shape is freely determined, and a plurality of membrane electrode assemblies may be combined in series or in parallel.

Method for Manufacturing Membrane Electrode Assembly

A method for manufacturing a membrane electrode assembly in the present invention includes at least the steps of bringing a functional compound containing a sulfonic group and/or a compound containing a phosphoric group into contact with pore portions of a porous polymer membrane (hereafter referred to as a contacting step), chemically bonding the porous polymer membrane and the functional compound together by electron beam irradiation (hereafter referred to as a bonding step), removing excess functional compounds present in the neighborhood of surfaces of the porous polymer membrane by cleaning (hereafter referred to as a cleaning step), applying a precursor paste of a catalyst-supporting conductive material to the neighborhood of the surfaces of the porous polymer membrane (hereafter referred to as a coating step), and drying the above-described paste after diffusion layers are affixed to the surfaces of the paste (hereafter referred to as an affixing and drying step).

In the contacting step, the method for bringing the porous polymer membrane and the functional compound into contact with each other is not specifically limited. For example, the porous polymer membrane may be simply immersed in a liquid composed of the functional compound. If necessary, an ultrasonic vibration may be applied, and vacuum filtration or pressure filtration may be used in combination in order to further increase the contact efficiency.

The types of compounds containing a sulfonic group and compounds containing a phosphoric group constituting the functional compound are not specifically limited. However, compounds containing large proportions of the sulfonic group and the phosphoric group can be used in order to increase the electric power generation efficiency of the membrane electrode assembly. For example, the molecular weight per functional group can be about 500 or less.

Preferably, the compounds containing a sulfonic group and the compounds containing a phosphoric group have functional groups that are sensitive to electron beam irradiation, because such groups improve the chemical bonding strength. Examples of functional groups sensitive to electron beam irradiation include those with unsaturated bonds, for example, double bonds and triple bonds. Among such groups, a methacrylic group, an acrylic group, a vinyl group, and a styrene group exhibit a particularly high sensitivity.

Examples of compounds containing a sulfonic group and a functional group sensitive to the electron beam include vinylsulfonic acid, allylsulfonic acid, styrenesulfonic acid, sulfobutyl methacrylates, sulfopropyl methacrylates, 2-acrylamide-2-methylpropanesulfonic acid, sulfobenzene methacrylates, and sulfobenzyl methacrylates. Monomers prepared by introducing fluorine into these monomers may also be used. Different types of these monomers may be used in combination.

(Meth)acrylic acid ester derivatives containing a phosphoric acid ester group in a side chain can be suitable for use as compounds containing a phosphoric group and a functional group sensitive to the electron beam.

In order to strengthen the chemical bond in the bonding step, an appropriate amount of a cross-linking promoter may be added to the functional compound. The promoter can exhibit sensitivity to the electron beam. Examples of suitable cross-linking promoters include an acrylamide, an acrylonitrile, and N-vinyl pyrrolidone.

Small amounts of an appropriate solvent may be added to the functional compound for the purpose of controlling the viscosity.

The amount of electron beam irradiation is not specifically limited, but it is, preferably, about 100 Gy or more and about 10 MGy or less, more preferably, about 5 kGy or more and about 200 kGy or less. If the amount of irradiation is less than about 100 Gy, chemical bonds are not adequately formed. If the amount of irradiation is larger than about 10 MGy, the polymer membrane and the proton conductive group may be denatured.

The acceleration voltage of the electron beam varies depending on the thickness of the electrolyte membrane. For example, the acceleration voltage can be about 50 kV to about 2 MV for the film of about 15 μm to about 150 μm. A plurality of electron beams having different acceleration voltages may be applied. Alternatively, the acceleration voltage may be changed during the application of the electron beam. If necessary, a heat treatment may be conducted while an active energy ray is applied, or immediately thereafter.

In the cleaning step, excess functional compounds present in the neighborhood of the surfaces of the polymer membrane are removed. By performing this operation, porous portions can be reconstructed in the neighborhood of the surfaces of the polymer membrane. The cleaning technique is not specifically limited. However, effective cleaning can be conducted by immersion in a solvent in which the functional compound can be dissolved before the application of the electron beam, and conducting a rubbing treatment in the solvent.

In the coating step, a precursor paste of a catalyst-supporting conductive material is applied to the surfaces of the polymer membrane. The precursor paste may contain an electrolytic material and an organic solvent in addition to the catalyst-supporting conductive material. Examples of electrolytic materials suitable for the present invention include fluoropolymers having proton conductive groups, for example, Nafion (registered trademark, DuPont), a fluorooligomer sulfonate, a sulfonated polyimide, and a sulfonated oligomer.

The method for applying the paste is not specifically limited. Examples thereof include a bar coating method, a spin coating method, a screen printing method, an air doctor coater method, a blade coating method, a rod coating method, a knife coating method, a squeeze coating method, a dip coating method, a comma coating method, a die coating method, a reverse roll coating method, a transfer roll coating method, a gravure coating method, a kiss roll coating method, a cast coating method, a spray coating method, a curtain coating method, a calender coating method, and an extrusion coating method.

The amount of penetration of the paste in the porous polymer membrane is not specifically limited. However, the depth of penetration per one surface is, preferably, about 1% or more and less than about 50% of the thickness of the porous polymer membrane. The amount of the penetration of the paste in the porous polymer membrane can be freely controlled by the viscosity of the paste and the amount applied.

The application thickness of the paste, when measured from the surface of the porous polymer membrane, is, preferably, about 1 mm or less in terms of solid matter, more preferably, within the range of about 0.5 μm to about 50 μm. If the thickness is less than about 0.5 μm, a fine pinhole, a crack, and the like, tend to occur when drying is conducted in the following step. However, if the thickness exceeds about 50 μm, the membrane resistance may increase.

In the affixing and drying step, the diffusion layers are affixed before the applied precursor paste is dried. Drying may be conducted in air or in an inert gas atmosphere at room (or higher) temperature until the solvent is adequately volatilized.

### EXAMPLES

The present invention will be more specifically described below with reference to specific examples. However, the present invention is not limited to such examples and covers any modification and the like within the scope and spirit of the invention.

### Example 1

Manufacturing Example of Membrane Electrode Assembly

A functional compound solution was prepared in a plastic container by mixing vinylsulfonic acid with an equal amount, by weight, of methacroyloxyethyl phosphate (trade name P-1M, produced by Kyoeisha Chemical Co., Ltd.). A polyimide membrane having a thickness of 15 μm and an average pore diameter of 0.1 μm and serving as a porous polymer membrane was immersed in the resulting solution, and the container and all internal components were subjected to an ultrasonic treatment for 5 minutes. The polyimide membrane was taken out of the container, transferred onto a smooth SUS plate and irradiated with an electron beam with an acceleration voltage of 200 kV and a dose rate of 50 kGy by using an electron beam irradiation device (EC250/15/180L, produced by IWASAKI ELECTRIC Co., Ltd.).

The polyimide membrane, after having been irradiated, was transferred into a methanol/water mixed solution (mixed at equal volumes) and heated to 60° C., and the surfaces of the membrane were cleaned by rubbing with a sponge, so that excess functional compounds covering the surfaces were removed. The membrane, after having been cleaned, was air-dried once.

The surfaces of the membrane, after having been cleaned, were observed with a scanning electron microscope. As a result, it appeared that a plurality of the pores having an average diameter of 0.1 μm were present in the neighborhood of the surfaces.

A paste serving as a precursor paste of the catalyst-supporting conductive material on the anode side was prepared by adequately mixing 1 g of carbon (produced by Tanaka Kikinzoku Kogyo K.K.) carrying 60 percent by weight of Pt—Ru catalyst (Pt:Ru=1:1, atomic ratio) and 5 g of 5-percent-by-weight Nafion solution (produced by Aldrich). A paste serving as a precursor paste of the catalyst-supporting conductive material on the cathode side was prepared by adequately mixing 1 g of carbon (produced by Tanaka Kikinzoku Kogyo K.K.) carrying 60 percent by weight of Pt catalyst and 5 g of 5-percent-by-weight Nafion solution. These precursor pastes were applied to their respective surfaces of the cleaned polyimide membrane by a bar coating method in such a way that the membrane thicknesses was 1 μm in terms of a solid material, and carbon paper (TGP-H-30, thickness 0.1 mm, produced by Toray Industries, Ltd.) serving as a diffusion layer was affixed to the outside of each precursor paste. This structure was hot-pressed at 100° C. for 5 minutes. Thereafter, vacuum drying was conducted at room temperature, so that a membrane electrode assembly of the present invention was produced.

A cross-section of the membrane electrode assembly was observed with a scanning electron microscope. As a result, both the maximum depths of embedding of the catalyst-supporting conductive material on the anode side and the cathode side were about 3 μm. That is, each depth was 20% of the membrane thickness of the polyimide membrane.

### Example 2

Manufacturing Example of Membrane Electrode Assembly

A membrane electrode assembly of the present invention was produced as in Example 1, except that two thicknesses of PTFE membrane filters (thickness 75 μm, average pore diameter 3 μm) were used as the porous polymer membrane, and the acceleration voltage of electron beam irradiation was specified to be 300 kV.

During the production, it appeared that a plurality of pores having an average diameter of 3 μm were present in the surface of the PTFE membrane after the cleaning step.

A cross-section of the membrane electrode assembly was observed with a scanning electron microscope. As a result, both the maximum depths of embedding of the catalyst-supporting conductive material on the anode side and the cathode side were about 10 μm. That is, each depth was 6.7% of the membrane thickness of the polyimide membrane.

### Comparative Example 1

Manufacturing Example of Membrane Electrode Assembly

A monomer aqueous solution was prepared by dissolving acrylamide methylpropylsulfonic acid, methylene-bis-acrylamide, and 2,2′-azobis(2-amidinopropane) dibasic acid (V-50, produced by Wako Pure Chemical Industries, Ltd.) serving as a reaction initiator in water at a weight ratio of 50:30:1. The same porous polyimide membrane as that used in Example 1 was immersed in the resulting solution. Thereafter, the polyimide membrane was taken out and sandwiched between glass plates. The sandwich was left standing for 12 hours in a dryer at 50° C. Thereby, heat polymerization was conducted. This operation was repeated three times, so that the inside of the porous polymer membrane was filled with polymerization products. Finally, excess polymers that were adhered to the surfaces of the membrane with a weak force were removed with pure water, so that the membrane became smooth.

Catalyst-supporting conductive materials and diffusion layers were bonded to both surfaces of the resulting membrane in a manner similar to that in Example 1, so that a membrane electrode assembly for the purpose of comparison was produced. When a cross-section of the membrane electrode assembly was observed with a scanning electron microscope, the interface between the catalyst-supporting conductive material and the polyimide membrane was clear, and substantially no embedding was established.

The membrane electrode assemblies produced in the above-described Examples 1 and 2 and Comparative Example 1 were incorporated into evaluation cells so as to construct the forms of polymer electrolyte fuel cells, and an operation was conducted with each single cell.

Electric power was generated while a 5-percent-by-weight methanol aqueous solution was supplied at 10 ml/min on the anode side, air at normal pressure was supplied at 100 ml/min on the cathode side, and the entire cell was kept at a temperature of 80° C.

The terminal voltage when electric discharge was conducted at a current density of 0.25 A/cm² is shown in Table 1.

TABLE 1

| | Terminal voltage (V) |
|---|---|
| Example 1 | 0.51 |
| Example 2 | 0.38 |
| Comparative Example 1 | 0.22 |

It is believed that the internal resistance of the entire membrane electrode assembly in Examples 1 and 2 is reduced, because the area of the interface portion between the catalyst-supporting conductive material and the electrolyte membrane is increased, and the three-phase interface is adequately formed. Therefore the output performance of the polymer electrolyte fuel cell is improved.

Incisions in a lattice pattern at intervals of 2 mm were made on the diffusion layer portions on the anode side of the membrane electrode assemblies produced in the above-described Examples 1 and 2 and Comparative Example 1. A 24 mm wide cellophane tape was affixed on the resulting surface and was peeled off with force at an angle of about 45 degrees. As a result, in the membrane electrode assembly of Example 1, peeling was observed randomly at portions constituting about 5% of the surface area. In the membrane electrode assembly of Example 2, peeling was hardly observed. However, in the membrane electrode assembly of Comparative Example 1, peeling was observed over at least 50% of the surface.

As described above with reference to Examples, one of the important features of the present invention is the configuration of the components constituting the membrane electrode assembly and the interface. Therefore, the type of the raw material used and the manufacturing apparatus are not specifically limited.

According to the present invention, a membrane electrode assembly suitable for ensuring compatibility between the strength and the high-output electric power generation property, a method for manufacturing a membrane electrode assembly, and a polymer electrolyte fuel cell can be provided.

While the present invention has been described with reference to exemplary embodiments, it is to be understood that the invention is not limited to these embodiments. The scope of the following claims is to be accorded the broadest interpretation so as to encompass all modifications, equivalent structures and functions.

This application claims the benefit of Japanese Application No. 2005-057996 filed Mar. 2, 2005, which is hereby incorporated by reference herein in its entirety.

What is claimed is:

1. A membrane electrode assembly comprising:
a polymer electrolyte membrane having a first surface and a second surface; and
diffusion layers bonded to the first and second surfaces of the polymer electrolyte membrane,
wherein the polymer electrolyte membrane comprises a porous polymer membrane, proton conductive groups disposed in pores of the porous polymer membrane, and a catalyst-supporting conductive material embedded in pores at least in a neighborhood of at least one surface of the porous polymer membrane.

2. The membrane electrode assembly according to claim 1, wherein the proton conductive groups and the porous polymer membrane are chemically bonded together.

3. The membrane electrode assembly according to claim 1, wherein the proton conductive groups are sulfonic groups and/or phosphoric groups.

4. The membrane electrode assembly according to claim 1, wherein a thickness of the porous polymer membrane is about 15 μm or more and about 150 μm or less.

5. The membrane electrode assembly according to claim 1, wherein a depth of embedding of the catalyst-supporting conductive material is about 1% or more and less than about 50% of a thickness of the porous polymer membrane.

6. The membrane electrode assembly according to claim 1, wherein an average diameter of the pores on a surface of the porous polymer membrane is about 0.1 μm or more and about 10 μm or less.

7. The membrane electrode assembly according to claim 1, wherein the porous polymer membrane is insoluble in water.

8. The membrane electrode assembly according to claim 1, wherein the porous polymer membrane comprises a polymer selected from the group consisting of a polyimide polymer, a polytetrafluoroethylene polymer, a polyamide polymer, a polyimide-amide polymer, and a polyolefin polymer.

9. A method for manufacturing a membrane electrode assembly, comprising the steps of:
bringing a functional compound comprising a sulfonic group and/or a compound comprising a phosphoric group into contact with pore portions of a porous polymer membrane;
chemically bonding the porous polymer membrane and the functional compound together by electron beam irradiation;
removing excess functional compounds present in a neighborhood of surfaces of the porous polymer membrane;
applying a precursor paste of a catalyst-supporting conductive material to the neighborhood of the surfaces of the porous polymer membrane;
affixing diffusion layers to the surfaces to which the precursor paste has been applied; and
drying the paste after diffusion layers are affixed to the surfaces of the paste.

10. A polymer electrolyte fuel cell comprising the membrane electrode assembly according to claim 1 and electrodes to transport outside current generated in the membrane electrode assembly.
